(19) United States
(12) Patent Application Publication
(10) Pub. No.: US 2023/0412479 A1
(43) Pub. Date: Dec. 21, 2023

(54) LOCAL MANAGEMENT OF QUALITY OF EXPERIENCE IN A HOME NETWORK

(71) Applicant: AT&T Intellectual Property I, L.P., Atlanta, GA (US)

(72) Inventors: Zhengye Liu, Pleasanton, CA (US); Yali Liu, Dublin, CA (US); Jin Wang, Fremont, CA (US); Raghvendra Savoor, Walnut Creek, CA (US)

(21) Appl. No.: 17/807,668

(22) Filed: Jun. 17, 2022

(51) Int. Cl. H04L 43/08

(52) U.S. Cl. CPC H04L 43/08

(57) ABSTRACT

In one example, the present disclosure describes a device, computer-readable medium, and method for locally managing quality of experience in a home network. For instance, in one example, a method performed by a residential gateway connected to a home network includes capturing network data relating to a plurality of software applications executing on a plurality of user endpoint devices connected to the home network, converting the network data into at least one network condition metric, receiving a query from a first software application of the plurality of software applications for at least one current condition of the home network, and delivering the at least one network condition metric to the first software application.

The present disclosure relates generally to network Quality of Experience (QoE), and relates more particularly to devices, non-transitory computer-readable media, and methods for locally managing quality of experience in a home network.

### BACKGROUND

WiFi is often used as the last hop to connect user endpoint devices in a home network to the home network's residential gateway. Over the last several years, WiFi performance (e.g., in terms of reliability, speed, latency, and the like) has improved tremendously, allowing users to enjoy more sophisticated network applications such as video streaming, conferencing, immersive gaming, and others in the users' home networks. Some of these network applications may be capable of dynamically adapting their operations in response to changes in the conditions of the home network (e.g., changes in latency, throughput, congestion, packet loss, jitter, and the like).

### SUMMARY

In one example, the present disclosure describes a device, computer-readable medium, and method for locally managing quality of experience in a home network. For instance, in one example, a method performed by a residential gateway connected to a home network includes capturing network data relating to a plurality of software applications executing on a plurality of user endpoint devices connected to the home network, converting the network data into at least one network condition metric, receiving a query from a first software application of the plurality of software applications for at least one current condition of the home network, and delivering the at least one network condition metric to the first software application.

In another example, a non-transitory computer-readable medium stores instructions which, when executed by a processing system of a residential gateway connected to a home network, cause the processing system to perform operations. The operations include capturing network data relating to a plurality of software applications executing on a plurality of user endpoint devices connected to the home network, converting the network data into at least one network condition metric, receiving a query from a first software application of the plurality of software applications for at least one current condition of the home network, and delivering the at least one network condition metric to the first software application.

In another example, a residential gateway includes a processing system and a non-transitory computer-readable medium storing instructions which, when executed by the processing system, cause the processing system to perform operations. The operations include capturing network data relating to a plurality of software applications executing on a plurality of user endpoint devices connected to a home network to which the residential gateway is connected, converting the network data into at least one network condition metric, receiving a query from a first software application of the plurality of software applications for at least one current condition of the home network, and delivering the at least one network condition metric to the first software application.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates a flowchart of an example method for locally managing quality of experience in a home network;

FIG. 3 illustrates a flowchart of an example method for locally managing quality of experience in a home network; and

FIG. 4 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure provides a system, method, and non-transitory computer readable medium for locally managing quality of experience in a home network. As discussed above, WiFi is often used as the last hop to connect user endpoint devices in a home network to the home network's residential gateway. Over the last several years, WiFi performance (e.g., in terms of reliability, speed, latency, and the like) has improved tremendously, allowing users to enjoy more sophisticated network applications such as video streaming, conferencing, immersive gaming, and other applications in the users' home networks.

However, even as WiFi performance has improved, these more sophisticated applications have come to place even greater demands on WiFi performance. Moreover, some widely used types of access networks (including, for example, very high-speed digital subscriber line, or VDSL, networks) can still create bottlenecks for applications, challenging a network service provider's ability to provide the required Quality of Experience (QoE) to customers. One common way to maintain QoE is to provide applications with the ability to adapt to changes in the underlying network conditions. For instance, streaming protocols such as dynamic adaptive streaming over hypertext transfer protocol (DASH) and hypertext transfer protocol live streaming (HLS) may automatically select a video segment with the highest bit rate possible that can be downloaded in time for playback without causing stalls or re-buffering events in the playback. However, these adaptive streaming techniques are only able to manage QoE at the individual application level (assuming an application is capable of adaptation). The adaptive techniques also rely on timely prediction of changing network dynamics and conditions, where potentially multiple devices in the home network may be competing over limited wireless and access network resources. Thus, conventional adaptive techniques typically lack a view of the “big picture” when it comes to the home network, and are only able to make predictions based on their own measurements.

Examples of the present disclosure extend the concept of network guidance in cellular networks to improve home network QoE. Within the context of cellular networks, network guidance is understood to refer to the use of a cellular base station (which has greater visibility into a network cell than any individual user endpoint device connected to the cell) to expose information of network conditions to applications executing in the network. However, in a home network, everything is “local.” In other words, the network is local, the applications are local, and the data is local; thus, the network guidance is also implemented locally.

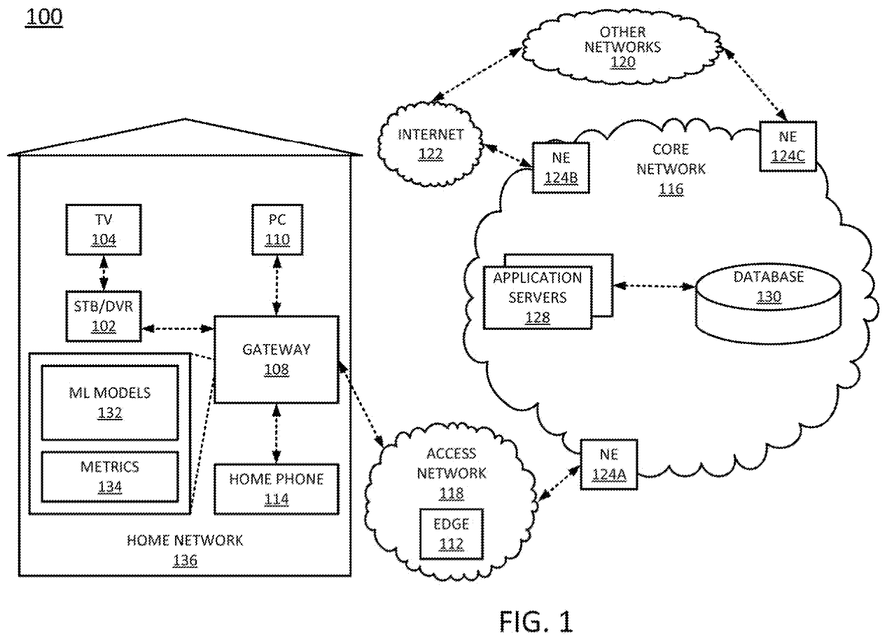

More particularly, examples of the present disclosure provide a distributed system for providing network guidance in a home network, without the use of a centralized data service. In one example, the home network's residential gateway is used to capture home network data, since the residential gateway is in the best position to observe all traffic inside the home network as well as all traffic coming into and going out of the home network. Additionally, the residential gateway has visibility into all network layers of the home network, from the physical layer to the application layer. Analysis functionality in the residential gateway converts the captured home network data into useful metrics from which network conditions can be predicted, such as throughput, latency, congestion, packet loss, jitter, and/or other metrics. Then, when a software application running in the home network needs to predict network conditions, the software application may query the residential gateway for the metrics. Thus, all data collection, analysis, and publication is performed locally within the home network, without reliance on a centralized data service outside of the home network. These and other aspects of the present disclosure are discussed in further detail with reference to FIGS. 1-4, below.

To better understand the present disclosure, FIG. 1 illustrates an example system 100 related to the present disclosure. As shown in FIG. 1, the system 100 may comprise a network 116, e.g., a telecommunication service provider network, a core network, or an enterprise network comprising infrastructure for computing and communications services of a business, an educational institution, a governmental service, or other enterprises. The network 116 may be in communication with one or more access networks (e.g., access network 118), other networks 120, and the Internet 122. In one example, network 116 may combine core network components of a cellular network with components of a triple play service network; where triple-play services include telephone services, Internet or data services and television services to subscribers. For example, network 116 may functionally comprise a fixed mobile convergence (FMC) network, e.g., an IP Multimedia Subsystem (IMS) network. In addition, network 116 may functionally comprise a telephony network, e.g., an Internet Protocol/Multi-Protocol Label Switching (IP/MPLS) backbone network utilizing Session Initiation Protocol (SIP) for circuit-switched and Voice over internet Protocol (VoIP) telephony services. Network 116 may further comprise a broadcast television network, e.g., a traditional cable provider network or an internet Protocol Television (IPTV) network, as well as an Internet Service Provider (ISP) network. In one example, network 116 may include a plurality of television (TV) servers (e.g., a broadcast server, a cable head-end), a plurality of content servers, an advertising server (AS), an interactive TV/video on demand (VoD) server, and so forth.

In one example, the access network 118 may comprise a broadband optical and/or cable access network, a Local Area Network (LAN), a wireless access network (e.g., an IEEE 802.11/Wi-Fi network and the like), a cellular access network, a Digital Subscriber Line (DSL) network, a public switched telephone network (PSTN) access network, a 3^{rd} party network, and the like. For example, the operator of network 116 may provide a cable television service, an IPTV service, or any other types of telecommunication service to subscribers via access network 118. In one example, the network 116 may be operated by a telecommunication network service provider. The network 116 and the access network 118 may be operated by different service providers, the same service provider or a combination thereof, or may be operated by entities having core businesses that are not related to telecommunications services, e.g., corporate, governmental or educational institution LANs, and the like. As shown in FIG. 1, the network 116 may also include a plurality of application servers 128 and a database 130. For ease of illustration, various additional elements of core network 116 are omitted from FIG. 1.

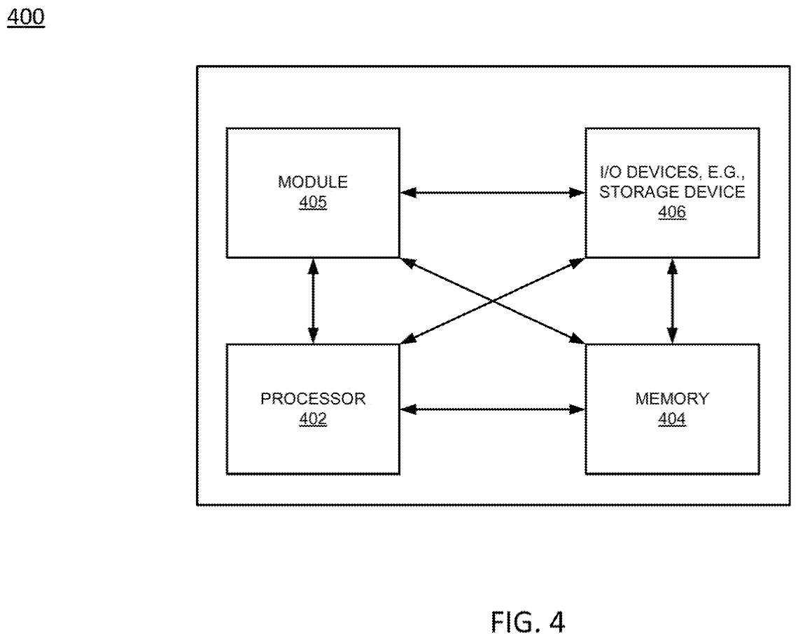

In accordance with the present disclosure, network 116 may include a plurality of application servers (AS) 128, each of which may comprise a computing system or server, such as computing system 400 depicted in FIG. 4, and may be configured to provide services to devices in a home network 136, as discussed in further detail below. The network 116 may also include at least one database (DB) 130 that is communicatively coupled to the AS 128. For instance, an AS 128 may provide a streaming media service, such as a streaming video service, and the DB 130 may store video content that can be accessed via the streaming video service. Alternatively, an AS 128 may provide an immersive gaming service, and the DB 130 may store interactive game objects that can be rendered by the immersive gaming service.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure. Thus, it should be noted that any number of servers and any number of databases may be deployed in the network 116. Furthermore, these servers and databases may operate in a distributed and/or coordinated manner as a processing system to perform operations in connection with the present disclosure.

In one example, access network 118 may include an edge server 112, which may comprise a computing system or server, such as computing system 400 depicted in FIG. 4, and may be configured to provide any of the services provided by any of the application servers 128.

In one example, any of the application servers 128 may comprise a network function virtualization infrastructure (NFVI), e.g., one or more devices or servers that are available as host devices to host virtual machines (VMs), containers, or the like comprising virtual network functions (VNFs). In other words, at least a portion of the network 116 may incorporate software-defined network (SDN) components. Similarly, in one example, access network 118 may comprise an “edge cloud,” which may include a plurality of nodes/host devices, e.g., computing resources comprising processors, e.g., central processing units (CPUs), graphics processing units (GPUs), programmable logic devices (PLDs), such as field programmable gate arrays (FPGAs), or the like, memory, storage, and so forth. In an example where the access network 118 comprises a radio access network, the nodes and other components of the access network 118 may be referred to as a mobile edge infrastructure. As just one example, edge server 112 may be instantiated on one or more servers hosting virtualization platforms for managing one or more virtual machines (VMs), containers, microservices, or the like. In other words, in one example, edge server 112 may comprise a VM, a container, or the like.

In one example, home network 136 may include a gateway device 108 (e.g., a residential gateway), which receives streams of data associated with different types of media, e.g., television, phone, and Internet, and separates these communications for the appropriate digital devices to which the gateway device 108 is connected. The streams of data may be received via access network 118, for instance. In one example, television data files are forwarded to a smart television (TV) 104 to be decoded, recorded, and/or displayed. Similarly, Internet communications are sent to and received from gateway device 108, which may be capable of both wired and/or wireless communication. In turn, gateway device 108 receives streams of data from and sends streams of data to the appropriate devices, e.g., personal computer (PC) 110, home phone 114, and/or other devices. Each of these devices may be configured to support media content of particular file formats. TV 104 may also be configured to support media content of particular file formats. In one example, gateway device 108 may comprise a wired Ethernet router and/or an Institute for Electrical and Electronics Engineers (IEEE) 802.11 (Wi-Fi) router, and may communicate with respective devices in home network 136 via wired and/or wireless connections.

In one example, the gateway device 108 may be configured to perform functions in connection with examples of the present disclosure for locally managing quality of experience in a home network 136. For instance, in one example, the gateway device may be configured to capture network data relating to a plurality of software applications executing on the smart TV 104, home phone 114, PC 110, and/or other devices in the home network 136 (broadly, “home network devices”). The network data may include data packets exchanged between the home network devices and the application servers 128. For instance, if the smart TV 104 is streaming video from an AS 128, the network traffic may include packets containing video chunks of a particular program.

In one example, the gateway device 108 may be further configured to utilize one or more machine learning (ML) models 132 to convert the network data into network condition metrics 134. The ML models 132 may utilize machine learning techniques (e.g., support vector machines, convolutional neural networks, random forest, linear regression, and/or other machine learning techniques) that have been trained to receive as input the network data and to produce as output a prediction as to the corresponding value of at least one network condition metric 134 of the home network 136, such as throughput, latency, congestion, packet loss, jitter, and/or other metrics. The gateway device 108 may store predicted values for the network condition metrics and provide the predicted values to requesting software applications executing on the home network devices. For instance, a streaming video application executing on the smart TV 104 may query the gateway device 108 for the current throughput or latency in order to help determine which video chunks (e.g., which bitrates of video chunks) to download from an AS 128. The gateway device 108 may continuously generate predictions for the values of the network condition metrics 134 and may store these predictions for a period of time. For instance, the gateway device may generate new predictions periodically (e.g., every x minutes), and, as new predictions are generated, older predictions may be discarded. In this way, a requesting application can be provided with the most recently generated prediction for a network condition metric. However, in other examples, the predictions may be generated on demand in response to a request from a software application.

It should be noted that as used herein, the terms “configure” and “reconfigure” may refer to programming or loading a computing device with computer-readable/computer-executable instructions, code, and/or programs, e.g., in a memory, which when executed by a processor of the computing device, may cause the computing device to perform various functions. Such terms may also encompass providing variables, data values, tables, objects, or other data structures or the like which may cause a computer device executing computer-readable instructions, code, and/or programs to function differently depending upon the values of the variables or other data structures that are provided.

Those skilled in the art will realize that the network 100 may be implemented in a different form than that which is illustrated in FIG. 1, or may be expanded by including additional endpoint devices, access networks, network elements, application servers, etc. without altering the scope of the present disclosure. For example, core network 116 is not limited to an IMS network. Similarly, the present disclosure is not limited to an IP/MPLS network for VoIP telephony services, or any particular type of broadcast television network for providing television services, and so forth.

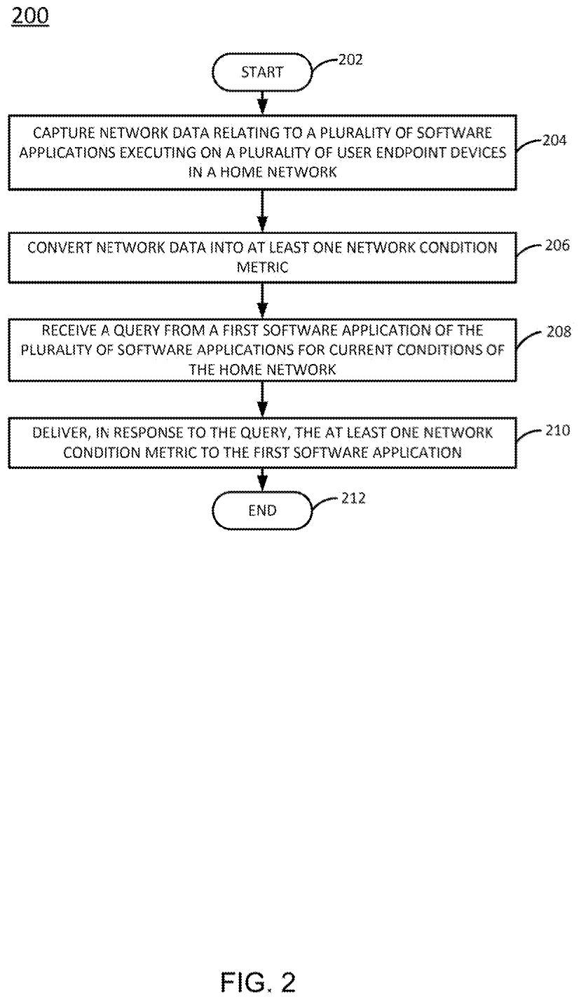

To further aid in understanding the present disclosure, FIG. 2 illustrates a flowchart of an example method 200 for locally managing quality of experience in a home network. In one example, the method 200 may be performed by the gateway device 108 illustrated in FIG. 1. However, in other examples, the method 200 may be performed by another device, such as the computing system 400 of FIG. 4, discussed in further detail below. For the sake of discussion, the method 200 is described below as being performed by a processing system (where the processing system may comprise a component of the gateway device 108, the computing system 400, or another device).

The method 200 begins in step 202. In step 204, the processing system may capture network data relating to a plurality of software applications executing on a plurality of user endpoint devices in a home network. In one example, network data relating to a software application includes data relating to any network traffic (e.g., data packets) for which a user endpoint device on which the software application is executing is an endpoint (e.g., a source or a destination of the network traffic). For instance, the network data may be collected at different network layers, and may include IP addresses, port numbers of transport sessions or flows, hypertext transfer protocol (HTTP) information of an HTTP session, generic traffic patterns (e.g., how many bytes are transmitted during a defined time period, such as a 250 millisecond period), WiFi signal strength and quality, network queue status (e.g., full, empty, etc.), packet retransmission rates at different network layers, and other data.

Thus, in one example, the processing system may utilize a packet analyzer or packet “sniffer” function (or a similar function) to intercept and log network traffic for which a user endpoint device on which the software application is executing is an endpoint. In one example, the processing system may record the headers of the individual packets of the network traffic; however, in another example, the processing system may additionally record at least a portion of the payloads (i.e., contents) of the packets.

A plurality of user endpoint devices may be connected to the home network at the same time, and any one or more of the plurality of user endpoint devices may be executing one or more software applications of the plurality of software applications at the same time. In one example, the plurality of user endpoint devices may include devices such as STB/DVRs, smart televisions, personal computers, tablet computers, gaming devices, home (e.g., landline) phones, mobile phones, IoT devices (e.g., smart thermostats, smart lighting systems, smart security systems, etc.), wearable devices (e.g., smart watches, fitness trackers, biometric or health monitors, head mounted displays and other virtual reality devices, etc.) and/or other devices including Internet of things (IoT) devices.

As discussed above, any one or more of the plurality of user endpoint devices may be executing one or more software applications of the plurality of software applications at the same time. The plurality of software applications may include, for example, media streaming applications, conferencing applications, gaming applications, voice communication applications, and/or other applications. For instance, a smart television connected to the home network may be streaming video from a video streaming service at the same time that a gaming system connected to the home network is streaming an immersive game and a personal computer connected to the home network is executing a virtual conferencing application. In one example, at least some software applications of the plurality of software applications may be capable of adapting their operation to changes in network conditions within the home network. For instance, if the plurality of software applications includes a video streaming application, the video streaming application may be configured for adaptive bitrate streaming (e.g., adjusting the quality of the video stream in response to the receiving device's real time bandwidth and central processing unit capacity).

In step 206, the processing system may convert the network data into at least one network condition metric. The at least one network condition metric may comprise a metric that indicates an ability of the home network to provide a desired (e.g., contracted) level of QoE. For instance, in one example, the at least one network condition may comprise at least one of: throughput, latency, congestion, packet loss, and jitter. In one example, conversion of the network data into the at least one network condition metric is performed using a machine learning technique that takes as input the network data and generates as a corresponding output a predicted value of the at least one network condition metric. For instance, a model that relies on support vector machines, convolutional neural networks, random forest, linear regression, and/or other machine learning algorithms may be trained to perform this conversion. In one particular example, the DeepTraffic deep reinforcement learning competition may be utilized to gain insight from the network data. For instance, algorithm on which the DeepTraffic deep reinforcement learning competition relies may apply deep learning on a traffic pattern to classify Internet traffic to specific applications (e.g., video streaming, video conferencing, etx.).

In step 208, the processing system may receive a query from a first software application of the plurality of software applications for one or more current conditions of the home network. For instance, as described above, in one example, the first software application may comprise a software application that is capable of adjusting its operation in response to changing network conditions in order to maintain a desired QoE. In one example, the query may comprise a query for a specific network condition metric (e.g., current or last-measured throughput). In another example, however, the query may comprise a more general query into the current network conditions. In one example, the processing system may receive the query for the current conditions of the home network via a gateway application programming interface (API).

In step 210, the processing system may deliver, in response to the query, the at least one network condition metric to the first software application. For instance, the processing system may deliver a report to the first software application (e.g., to the user endpoint device on which the first software application is executing) that includes a most recent measurement or calculation for the at least one network condition metric. In one example, the processing system may publish the at least one network condition metric via the gateway API through which the query was received.

The method 200 may end in step 212. However, the processing system may repeat one or more of steps 204-210 on a continuous, periodic, event-driven, or other basis. For instance, the processing system may continuously capture the network data and convert the network data into network condition metrics. However, the processing system may deliver the network condition metrics responsively to received queries from software applications. In this way, the operation of the plurality of software applications may continue to adapt to network conditions as the network conditions potentially change over time. In other examples, the order of certain steps could be altered. For instance, in some examples, the processing system may convert the network data into network condition metrics on demand, after receiving a query from the first software application.

Subsequent to execution of the method 200, the first software application may adjust its operation in response to the at least one network condition metric. For instance, if the first software application is a video streaming application executing on a smart television connected to the home network, and the at least one network condition metric indicates that the available network bandwidth to the smart television has decreased, then the video streaming application may decrease the bitrate of video chunks that the video streaming application is downloading from a remote video server. This may allow the video streaming application to continue streaming the video content on the smart television without stalls (albeit at a lower video quality), thus minimizing the impact of the decreased bandwidth on the experience of the user who is watching the video content.

Thus, examples of the present disclosure enhance home network performance and QoE without making extensive upgrades to the network itself. Instead, the functionality of the residential gateway is modified so that the residential gateway serves as a point for analyzing and exposing home network conditions to software applications that are executing in the home network (e.g., on user endpoint devices that are connected to the home network). Examples of the present disclosure therefore make novel use of existing network resources via a data-driven approach, without requiring significant investment in hardware and operation. All that is needed is an update to the software running on the residential gateway.

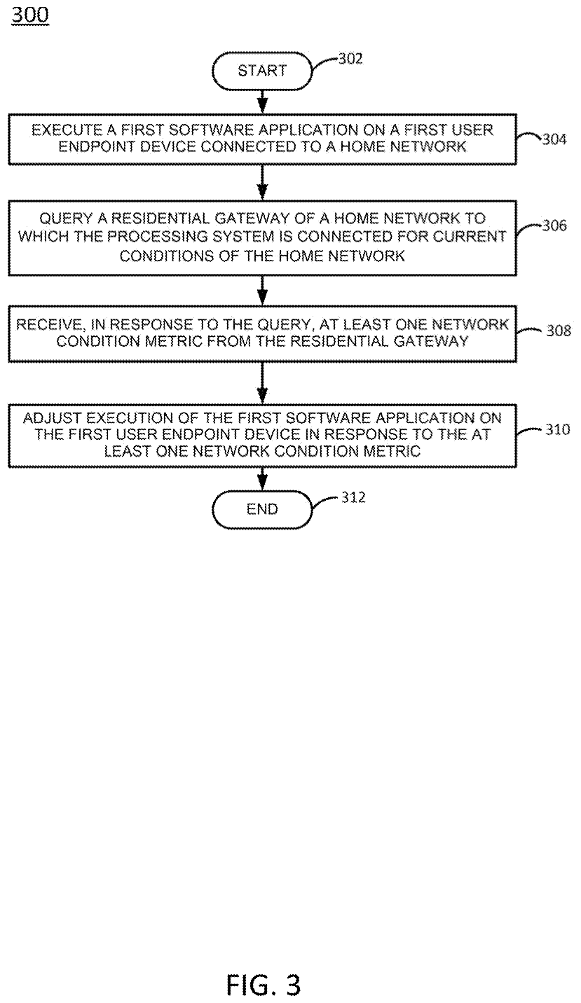

FIG. 3 illustrates a flowchart of an example method 300 for locally managing quality of experience in a home network. In one example, the method 300 may be performed by any of the customer devices or user endpoint devices illustrated in FIG. 1. However, in other examples, the method 300 may be performed by another device, such as the computing system 400 of FIG. 4, discussed in further detail below. For the sake of discussion, the method 300 is described below as being performed by a processing system (where the processing system may comprise a component of a customer device or user endpoint device, the computing system 400, or another device).

The method 300 begins in step 302. In step 304, the processing system may execute a first software application on a first user endpoint device connected to a home network. In one example, the first software application may be one of a plurality of software applications executing on a plurality of user endpoint devices (of which the first user endpoint device is one) connected to the home network. As discussed above, in one example, the first software application may comprise a software application that is capable of adjusting its operation in response to changing network conditions in order to maintain a desired QoE. At least some other applications of the plurality of software applications may also be capable of adjusting their operations in response to changing network conditions.

As also discussed above, the plurality of user endpoint devices may be connected to the home network at the same time, and any one or more of the plurality of user endpoint devices may be executing one or more software applications of the plurality of software applications at the same time. In one example, the plurality of user endpoint devices may include devices such as STB/DVRs, smart televisions, personal computers, tablet computers, gaming devices, home (e.g., landline) phones, mobile phones, IoT devices (e.g., smart thermostats, smart lighting systems, smart security systems, etc.), wearable devices (e.g., smart watches, fitness trackers, biometric or health monitors, head mounted displays and other virtual reality devices, etc.) and/or other devices. Thus, the first user endpoint device may comprise any of these devices, or a different type of Internet-connected device.

As also discussed above, any one or more of the plurality of user endpoint devices may be executing one or more software applications of the plurality of software applications at the same time. Thus, the first software application may include, for example, a media streaming application, a conferencing application, a gaming application, a voice communication application, and/or another application. For instance, the first software application may comprise a video streaming application executing on a smart television connected to the home network. At the same time that the first software application is streaming video to the smart television, a gaming system connected to the home network may be streaming an immersive game, and a personal computer connected to the home network may be executing a virtual conferencing application.

In step 306, the processing system may query a residential gateway of a home network to which the processing system is connected for one or more current conditions of the home network. In one example, the processing system may query the residential gateway for the current conditions of the home network periodically (e.g., every x minutes). In another example, the processing system may query the residential gateway for the current conditions of the home network in response to the detection of a predefined event, such as a QoE metric for the first software application falling below a predefined threshold. For instance, if the first software application is a video streaming application, and the processing system detects a stall in video playback that is longer than a predefined threshold stall (e.g., y seconds), then the processing system may determine that the residential gateway of the home network should be queried for the current network conditions.

In one example, the query may comprise a query for a specific network condition metric (e.g., current or last-measured throughput). In another example, however, the query may comprise a more general query into the current network conditions. In one example, the processing system may deliver the query for the current conditions of the home network via a gateway API.

In step 308, the processing system may receive, in response to the query, at least one network condition metric from the residential gateway. For instance, the processing system may receive a report that includes a most recently generated prediction (e.g., generated by the residential gateway using machine learning, as discussed above) for the at least one network condition metric. In one example, the report may be published or exposed to the processing system via the gateway API through which the query was generated.

In step 310, the processing system may adjust execution of the first software application on the first user endpoint device in response to the at least one network condition metric. The adjusting of the operation of the at least one software application may be performed under the instruction of the at least one software application. For instance, as discussed above, the first software application may be capable of adapting its operation to changes in network conditions within the home network. For instance, if the first software application includes a video streaming application, the video streaming application may be configured for adaptive bitrate streaming (e.g., adjusting the quality of the video stream in response to the receiving device's real time bandwidth and central processing unit capacity). Thus, the processing system may increase or decrease the bitrate of the video chunks that the processing system is downloading (e.g., increase or decrease relative to an immediately previously downloaded video chunk).

The method 300 may end in step 312. However, the processing system may repeat one or more of steps 304-310 for as long as the first software application continues to execute on the first user endpoint device. In this way, the operation of the first software application on the first user endpoint device may continue to adapt to network conditions as the network conditions potentially change over time.

Although not expressly specified above, one or more steps of the method 200 and 300 may include a storing, displaying, and/or outputting step as required for a particular application. In other words, any data, records, fields, and/or intermediate results discussed in the method can be stored, displayed and/or outputted to another device as required for a particular application. Furthermore, operations, steps, or blocks in FIGS. 2 and 3 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the examples of the present disclosure.

FIG. 4 depicts a high-level block diagram of a computing device specifically programmed to perform the functions described herein. For example, any one or more components or devices illustrated in FIG. 1 or described in connection with the methods 200 and 300 may be implemented as the system 400. For instance, the residential gateway 108 of FIG. 1 (such as might be used to perform the method 200) could be implemented as illustrated in FIG. 4. In another example, any of the customer devices or user endpoint devices of FIG. 1 (such as might be used to perform the method 300) could be implemented as illustrated in FIG. 4.

As depicted in FIG. 4, the system 400 comprises a hardware processor element 402, a memory 404, a module 405 for locally managing quality of experience in a home network, and various input/output (I/O) devices 406.

The hardware processor 402 may comprise, for example, a microprocessor, a central processing unit (CPU), or the like. The memory 404 may comprise, for example, random access memory (RAM), read only memory (ROM), a disk drive, an optical drive, a magnetic drive, and/or a Universal Serial Bus (USB) drive. The module 405 for locally managing quality of experience in a home network may include circuitry and/or logic for performing special purpose functions relating to locally managing quality of experience in a home network. The input/output devices 406 may include, for example, storage devices (including but not limited to, a tape drive, a floppy drive, a hard disk drive or a compact disk drive), a receiver, a transmitter, a fiber optic communications line, an output port, or a user input device (such as a keyboard, a keypad, a mouse, and the like).

Although only one processor element is shown, it should be noted that the general-purpose computer may employ a plurality of processor elements. Furthermore, although only one general-purpose computer is shown in the Figure, if the method(s) as discussed above is implemented in a distributed or parallel manner for a particular illustrative example, i.e., the steps of the above method(s) or the entire method(s) are implemented across multiple or parallel general-purpose computers, then the general-purpose computer of this Figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a general purpose computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for locally managing quality of experience in a home network (e.g., a software program comprising computer-executable instructions) can be loaded into memory 404 and executed by hardware processor element 402 to implement the steps, functions or operations as discussed above in connection with the example methods 200 and 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for locally managing quality of experience in a home network (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

1. A method comprising:
capturing, by a processing system of a residential gateway connected to a home network, network data relating to a plurality of software applications executing on a plurality of user endpoint devices connected to the home network;
converting, by the processing system, the network data into at least one network condition metric, wherein the at least one network condition metric indicates at least one of: a current throughput of the home network, a current latency of the home network, a current congestion of the home network, or a current jitter of the home network;
receiving, by the processing system, a query from a first software application of the plurality of software applications for at least one current condition of the home network; and
delivering, in response to the query by the processing system, the at least one network condition metric to the first software application.

2. The method of claim 1, wherein the network data relating to the plurality of software applications executing on the plurality of user endpoint devices includes network traffic for which a user endpoint device of the plurality of user endpoint devices is an endpoint.

3. The method of claim 2, wherein the processing system intercepts and logs data packets comprising the network traffic.

4. The method of claim 1, wherein the plurality of user endpoint devices is connected to the home network at a same time, and at least some software applications of the plurality of software applications are executing on the plurality of user endpoint devices at the same time.

5. The method of claim 1, wherein the first software application comprises a software application that is capable of adapting an operation to a change in the at least one current condition in the home network.

6. The method of claim 5, wherein the first software application comprises at least one of: a media streaming application, a conferencing application, a gaming application, or a voice communication application.

7. (canceled)

8. The method of claim 1, wherein the at least one current condition comprises at least one of: a throughput, a latency, a congestion, a packet loss, or a jitter.

9. The method of claim 1, wherein the query comprises a query for a specific network condition metric.

10. The method of claim 1, wherein the query comprises a general query into the at least one current condition of the home network.

11. The method of claim 1, wherein the query is received via a gateway application programming interface that exposes the at least one network condition metric to the plurality of software applications.

12. The method of claim 11, wherein the at least one network condition metric is delivered to the first software application via the gateway application programming interface.

13. The method of claim 1, wherein the capturing and the converting are performed continuously by the processing system.

14. The method of claim 1, wherein the delivering of the at least one network condition metric causes the first software application to adjust an execution of the first software application on a first user endpoint device.

15. The method of claim 1, wherein the converting is performed in response to the receiving the query.

16. The method of claim 1, wherein the at least one network condition metric comprises a predicted value of the at least one network condition metric.

17. The method of claim 1, wherein at least a portion of the network data comprises data packets exchanged between the first software application and an application server outside of the home network.

18. The method of claim 1, wherein the processing system stores the at least one network condition metric until the at least one network condition metric is recalculated using new network data relating to the plurality of software applications executing on the plurality of user endpoint devices.

19. A non-transitory computer-readable medium storing instructions which, when executed by a processing system of a residential gateway connected to a home network, cause the processing system to perform operations, the operations comprising:
capturing network data relating to a plurality of software applications executing on a plurality of user endpoint devices connected to the home network;
converting the network data into at least one network condition metric, wherein the at least one network condition metric indicates at least one of: a current throughput of the home network, a current latency of the home network, a current congestion of the home network, or a current jitter of the home network;
receiving a query from a first software application of the plurality of software applications for at least one current condition of the home network; and
delivering the at least one network condition metric to the first software application.

20. A residential gateway comprising:
a processing system; and
a computer-readable medium storing instructions which, when executed by the processing system, cause the processing system to perform operations, the operations comprising:
capturing network data relating to a plurality of software applications executing on a plurality of user endpoint devices connected to a home network to which the residential gateway is connected;
converting the network data into at least one network condition metric, wherein the at least one network condition metric indicates at least one of: a current throughput of the home network, a current latency of the home network, a current congestion of the home network, or a current jitter of the home network;
receiving a query from a first software application of the plurality of software applications for at least one current condition of the home network; and
delivering the at least one network condition metric to the first software application.

21. The method of claim 1, wherein the converting is performed using a machine learning technique that takes as an input the network data and generates as an output the at least one network condition metric.
